(19) United States
(12) Patent Application Publication
(10) Pub. No.: US 2015/0086127 A1
(43) Pub. Date: Mar. 26, 2015

(54) METHOD AND IMAGE CAPTURING DEVICE FOR GENERATING ARTIFICIALLY DEFOCUSED BLURRED IMAGE

(71) Applicant: Samsung Electronics Co., Ltd., Gyeonggi-do (KR)

(72) Inventors: K. Santle Camilus, Bangalore (IN); Sabari Raju Shanmugam, Bangalore (IN); Jayakarthick S., Bangalore (IN); Narasimha Gopalakrishna Pai, Bangalore (IN); Pankaj Kumar Bajpai, Bangalore (IN); Gaurav Kumar Jain, Bangalore (IN)

(73) Assignee: Samsung Electronics Co., Ltd, Gyeonggi-do (KR)

(21) Appl. No.: 14/274,657

(22) Filed: May 9, 2014

(30) Foreign Application Priority Data
Sep. 20, 2013 (IN) 4251/CHE/2013
Feb. 7, 2014 (KR) 10-2014-0014408

(51) Int. Cl. G06T 5/00; G06T 7/00; G06T 11/60

(52) U.S. Cl. CPC G06T 5/002; G06T 11/60; G06T 7/0081; G06T 2207/20024; G06T 2207/20182; G06T 2207/20221
USPC 382/264

(57) ABSTRACT

A method and an image capturing device configured to generate a defocused image from a reference image and one or more of focal bracketed images to provide an artificially defocused blurred image. The artificially defocused blurred image is a fusion image composed by processing the reference image and one or more of focal bracketed images to provide a clear foreground with gradual blurred background based on a created depth map. The method is time efficient as it provides faster processing on a captured and down sampled reference image and one or more captured down sampled aligned focal bracketed images. The depth map created using region based segmentation reduces a misclassification at a time of classifying foreground-background and misclassification of pixels to provide fast, robust artificial blurring of background in the captured reference image.

### CROSS-REFERENCE TO RELATED APPLICATION(S) AND CLAIM OF PRIORITY

The present application is related to and claims priority under 35 U.S.C. §119(a) to Indian Patent Application Serial No. 4251/CHE/2013, which was filed Indian Patent Office on Sep. 20, 2013 and Korean Application Serial No. 10-2014-0014408, which was filed in the Korean Intellectual Property Office on Feb. 7, 2014, the entire content of which is hereby incorporated by reference.

### TECHNICAL FIELD

The present invention relates to image processing and more particularly to the generation of an image with artificial defocused blurring using image processing techniques.

### BACKGROUND

Currently, image capturing devices are equipped with many interesting features such as auto focus, optical zoom, face detection, smile detection and so on. The image capturing device can be a mobile phone, a tablet Personal Computer (PC), a Personal Digital Assistant (PDA), a webcam, a compact digital camera or any device capable of image capturing which can be used to capture candid pictures.

Currently, the image capturing devices such as the mobile phone can have smaller camera apertures due to considerations such as cost, size, weight and the like. The smaller camera aperture can also affect a photographic element called depth of field (DOF). For example, an image capturing device with small aperture can be unable to capture images similar to a Digital Single-Lens Reflex (DSLR) that can use larger apertures. Such DSLR images can provide an aesthetic look to the captured image with a blurred background due to the use of large apertures. Generally, a user or a photographer can consciously control the DOF in an image for artistic purposes, aiming to achieve attractive background blur for the captured image. For example, shallow DOF can often be used for close up shots to provide a blurred background region with sharp focus on prime subject in the captured image. The image capturing device with small camera aperture can provide artificial defocus blurring of the captured image to generate defocused images similar to the image capturing devices with a large camera aperture.

Spatial aligning of multiple images captured at different focal lengths with reference to a captured reference image can be one of the primary steps of generating defocused images. With existing methods, image alignment for varying focal length (zoom) parameters can be a computationally intensive operation involving image feature extraction and matching. Existing methods can use pixel information to classify the pixel into a foreground and a background. However this can lead to frequent misclassification of the pixel due to several reasons such as misalignment of the focal bracketed images and outlier pixels. This misclassification of pixels alignment can cause artifacts in the image.

### SUMMARY

To address the above-discussed deficiencies, it is a primary object to provide a method and device to generate artificially defocused blurred image from a captured reference image and captured one or more of focal bracketed images.

Another object of the invention is to provide a method for compensating zoom of one or more captured focal bracketed images for aligning with the captured reference image based one or more zoom compensation parameters calibrated using one or more parameters of an image capturing device.

Another object of the invention is to provide a method to create a depth map for generating the defocused image by segmenting the captured reference image using region based segmentation to provide artificial defocus blurring of the captured reference image.

Accordingly the invention provides a method for generating an artificially defocused blurred image, wherein the method comprises compensating zoom of captured at least one focal bracketed image for aligning with a captured reference image based on at least one zoom compensation parameter. Further the method comprises creating a depth map for at least one pixel in at least one segmented region by down sampling the reference image. Further, the method generates a blurred reference image by performing defocus filtering on the down sampled reference image using a lens blur filter and composes a fusion image using at least one image between the captured reference image and an up sampled blurred reference image based on an up sampled depth map for generating the artificially defocused blurred image.

Accordingly the invention provides an image capturing device configured to generate an artificially defocused blurred image, wherein the device comprises an integrated circuit. Further, the integrated circuit comprises at least one processor; at least one memory having a computer program code. Further, the at least one memory and the computer program code with the at least one processor can cause the device to compensate for zoom of a focal bracketed image based on at least one zoom compensation parameter for aligning at least one captured focal bracketed image with a captured reference image. Further, the device is configured to create a depth map for at least one pixel in at least one segmented region by down sampling the reference image. Furthermore, the device is configured to generate a blurred reference image by performing defocus filtering on the down sampled reference image using a lens blur filter. Further, the device is configured to compose a fusion image using at least one image between the captured reference image and an up sampled blurred reference image based on an up sampled depth map for generating the artificially defocused blurred image.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example flow diagram of the generation of a defocused image from a captured reference image in order to provide artificial defocus blurring according to an embodiment of the present disclosure;

FIG. 2 illustrates an example flow diagram of the alignment of one or more captured focal bracketed images with the captured reference image according to an embodiment of the present disclosure;

FIG. 3 illustrates an example flow diagram of sharpness estimation of the down sampled captured reference image and the down sampled one or more captured focal bracketed images according to an embodiment of the present disclosure;

FIG. 4 illustrates an example flow diagram of the creation of a depth map by assigning a foreground identifier and a weighted background identifier to the pixels of the captured reference image according to an embodiment of the present disclosure;

FIG. 5 illustrates an example flow diagram for defocus filtering of the down sampled captured reference image according to an embodiment of the present disclosure;

FIG. 6 illustrates an example lens blur filter mask for defocus filtering of the down sampled captured reference image according to an embodiment of the present disclosure;

FIG. 7 illustrates an example flow diagram for composing a fusion image from the captured reference image and an up sampled blurred reference image, according to an embodiment of the present disclosure;

FIG. 8 illustrates an example of a captured reference image, focal bracketed image, and composed fusion image according to an embodiment of the present disclosure; and

FIG. 9 illustrates an example block diagram for a construction of a device block implementing the artificial defocus blurring of the captured reference image according to an embodiment of the present disclosure.

### DETAILED DESCRIPTION

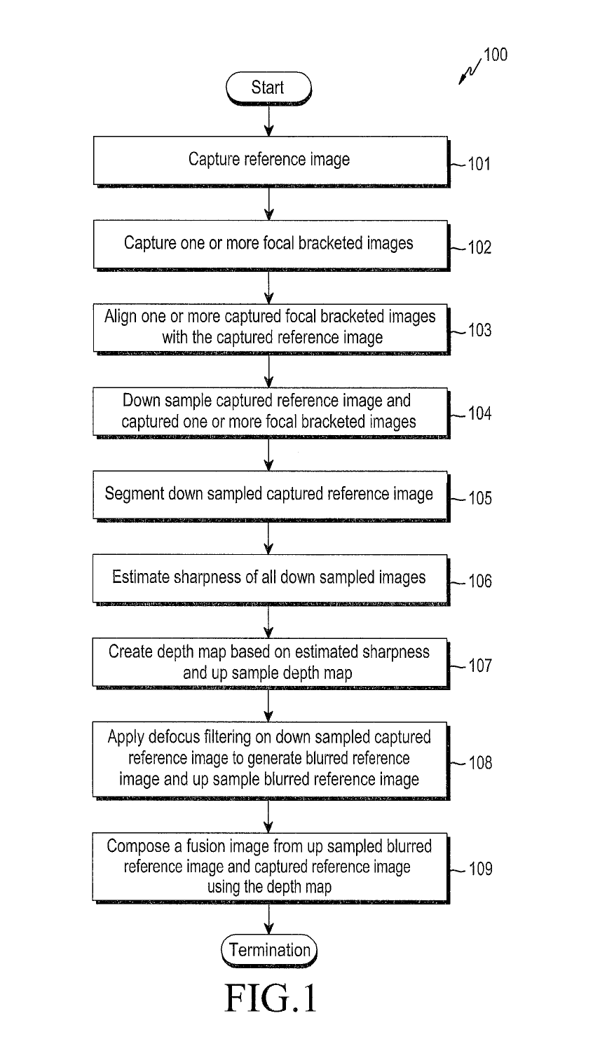

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged image capturing device. The embodiments herein and the various features and advantageous details thereof are explained with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein disclose a method and image capturing device for generating an artificially defocused blurred image from a captured reference image and captured one or more focal bracketed images. The reference image can be an image captured with the prime subject of the image in focus. The one or more focal bracketed images can be image(s) captured by adjusting the focal length of a lens in the device to different values so as to focus on subjects other than the prime subject in the image at various depth of field (DOF).

In an embodiment, the image capturing device can be for example, a mobile phone, a tablet Personal Computer (PC), a Personal Digital Assistant (PDA), a webcam, a compact digital camera, or any other image capturing hardware with a camera aperture.

The defocused image can be a fusion image composed by processing the captured reference image and the captured one or more of focal bracketed images to provide clear foreground with gradually blurred background based on a created depth map. Further the method can include a creation of the depth map by segmenting the captured reference image using region based segmentation. The method can enable an image capturing device having small camera apertures to generate defocused images similar to defocused images captured by the image capturing device having a large camera aperture.

The method can enable the image capturing device to capture the reference image and capture one or more focal bracketed images to provide artificial defocus blurring of the reference image by processing both the reference image and one or more focal bracketed images.

In an embodiment, the image processing at various stages can be performed on the down sampled reference image and down sampled one or more focal bracketed images enabling faster computations.

The method can provide up sampling of processed images at various stages of processing to compose the fusion image having size of the reference image. The captured reference image and the captured one or more focal bracketed images can be sub-sampled “n” times equally in height and weight, where “n” is a positive integer greater than or equal to 1 by considering pixels at regular interval depending on the value of “n” to construct a resized image. The images can be processed at a lower scale by down sampling so that an efficient processing can be provided by reducing execution time.

In an embodiment, the method can enable processing the reference image and one or more focal bracketed images without downscaling or down sampling.

The method can enable the image capturing device to compensate zoom of one or more focal bracketed images. The zoom compensation, based on one or more zoom compensation parameters, can be calibrated using one or more parameters of the image capturing device. The zoom alignment of multiple images using pre-determined values depending on their focal position can eliminate zoom calculation errors and can reduce an execution time for image alignment. The translation and rotation compensation provided can enable robust spatial alignment of one or more focal bracketed images with the captured reference image by reducing image registration errors.

One advantage of creating the depth map based on classification (such as segmentation) of a reference image rather than an individual pixel based classification can be the reduction in foreground-background misclassification of pixels of the captured reference image. The segmentation based depth map can be robust against outlier pixels and misalignment of one or more focal bracketed images with the captured reference image.

The various filters used during processing operations according to an embodiment can be implemented in hardware or software.

Throughout the description, the reference image and captured reference image can be used interchangeably. Throughout the description, the captured one or more focal bracketed images and one or more focal bracketed images can be used interchangeably.

Referring now to the drawings, and more particularly to FIGS. 1 through 9, where similar reference characters denote corresponding features consistently throughout the figures, there are shown several embodiments.

FIG. 1 illustrates an example flow diagram for explaining the generation of a defocused image from a captured reference image to provide artificial defocus blurring according to an embodiment of the present disclosure. As depicted in the FIG. 1 100, at step 101, the reference image can be captured by the image capturing device.

In an embodiment, the autofocus image captured by the image capturing device can be selected as the reference image.

Further, in step 102, the one or more focal bracketed images can be captured by varying the focal length of the image capturing device.

In an embodiment the number of focal bracketed images to be captured can be pre-determined.

In an embodiment, the image capturing device can be configured to decide the number of focal bracketed images to be captured based on factors such as image content, number of depths in the captured reference image, and the like.

For example, if the reference image has only one depth, the artificial defocus blurring of the reference image may not provide any better visual effect. Then, the image capturing device can operate in a normal image capturing mode rather than artificial defocus blurring mode and can avoid unnecessary processing and capturing of plurality of focal bracketed images, thereby reducing processor usage, battery power consumption of the image capturing device, and other such advantages.

In an embodiment, the user can manually select the artificial defocus blurring mode for the image capturing device.

In step 103, one or more focal bracketed images can be aligned with the captured reference image. The spatial alignment of one or more focal bracketed image can include zoom compensation, translation compensation, rotational compensation and similar compensation techniques. As every focal bracketed image has a different zoom operation based on the adjusted focus during capturing a corresponding image, the zoom compensation can enable aligning of one or more focal bracketed images for the zoom variations with reference to the reference image. The translation and rotation compensation can compensate for any translation and/or any rotational shift due to slight variations in the position of an image capturing device during capturing of one or more focal bracketed images.

Further, in step 104, the reference image and the one or more focal bracketed images can be down sampled by the image capturing device. The images can be processed at lower scale by down sampling so that efficient processing for time can be provided by reducing execution time. Further, in step 105, the down sampled reference image can be segmented into one or more segmented regions where pixels in each region exhibit similar characteristics.

In an embodiment, the image segmentation can be performed using region based segmentation techniques such as efficient graph based image segmentation, region merging, region splitting, region splitting, merging, and similar image segmentation techniques. In an embodiment, the segmentation can be performed by dividing the down sampled reference image into uniform regions. For example, uniform segmentation of regions can be preferred when segmented regions have blocks of size smaller than a predefined threshold block size.

Further, in step 106, the sharpness of all down sampled images including the down sampled reference image and one or more down sampled focal bracketed images can be estimated. Upon estimation of the sharpness, in step 107, region based depth map for every pixel of the down sampled reference image can be created based on the estimated sharpness. The estimated sharpness can enable the identifying of the pixels as foreground or background pixels. The depth map can provide a single maximum weight for pixels identified as foreground pixels. Whereas the pixels identified as background pixels can be assigned background weights depending on the estimated sharpness level of the pixels in the respective segmented regions.

Thereafter, the depth map created for the down sampled reference image based on one or more segmented regions can be up sampled to the size of captured reference image.

Further, in step 108, defocus filtering can be applied on the down sampled reference image to generate a blurred reference image. The blurring for the blurred reference image can be performed by using a lens blur filter. Further, the reference image can be selected for defocus filtering as it captures clearly focused foreground. The defocus filtering can generate blur similar to the camera lens blur and can provide a more natural blurring effect.

In an embodiment, the size of a lens blur filter mask can be pre-determined or can be dynamically selected by the image capturing device based on parameters such assure input setting, image characteristics, and the like.

The generated blurred reference image having size of down sampled reference image can then be up sampled to the size of the reference image. Thereafter, in step 109, the fusion image can be composed from the up sampled blurred reference image and the reference image using the up sampled depth map associated with every pixel. The composed fusion image can be the defocused image providing artificial defocus blurring of the reference image. The various operations (steps) in FIG. 100 can be performed in the order presented, or in a different order or simultaneously. Further, in some embodiments, some operations listed in FIG. 1 can be omitted.

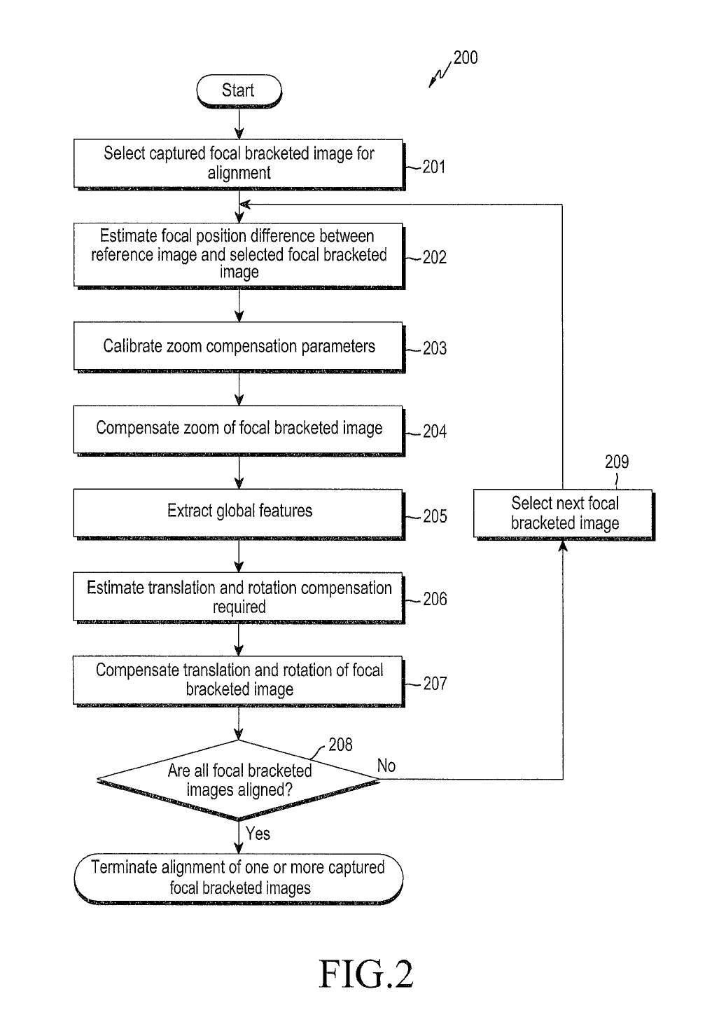

FIG. 2 illustrates an example flow diagram for the alignment of one or more captured focal bracketed images with the captured reference image according to an embodiment of the present disclosure. Referring to FIG. 2 200, in step 201, one among the captured focal bracketed images can be selected for spatial alignment with the reference image. Further, in step 202, focal position difference between the reference image and the selected a focal bracketed image can be estimated. Thereafter, in step 203, one or more zoom compensation parameters such as affine or the like can be calibrated using one or more parameters of the image capturing device such as focus code and the like. The focal code can be digital data associated with lens movement in the camera. Upon calibrating the zoom compensation parameters, in step 204, the zoom of selected focal bracketed image can be compensated.

Further to handle the rotational and translational variations in the selected focal bracketed image, in step 205, global features of the selected focal bracketed image can be extracted using any of the image feature extraction techniques. These extracted features can be used in step 206 and translation and rotation compensation can be estimated. Using the estimation, in step 207 translation and rotation can be compensated and the selected focal bracket image can be spatially aligned with the reference image. Thereafter, in step 208, check can be performed whether all focal bracketed images are processed for alignment.

If the focal bracketed images are left to be processed for alignment, then in step 209, the next focal bracketed image can be selected and the steps 201 to 208 can be repeated. If the entire focal bracketed images can be processed for alignment, then alignments of one or more focal bracketed images can be terminated. The aligned images can be used for further processing such as down sampling, sharpness estimation, and various other processing stages. The various operations (steps) in FIG. 2 200 can be performed in the order presented, in a different order or simultaneously. Further, in some embodiments, some operations listed in FIG. 2 can be omitted.

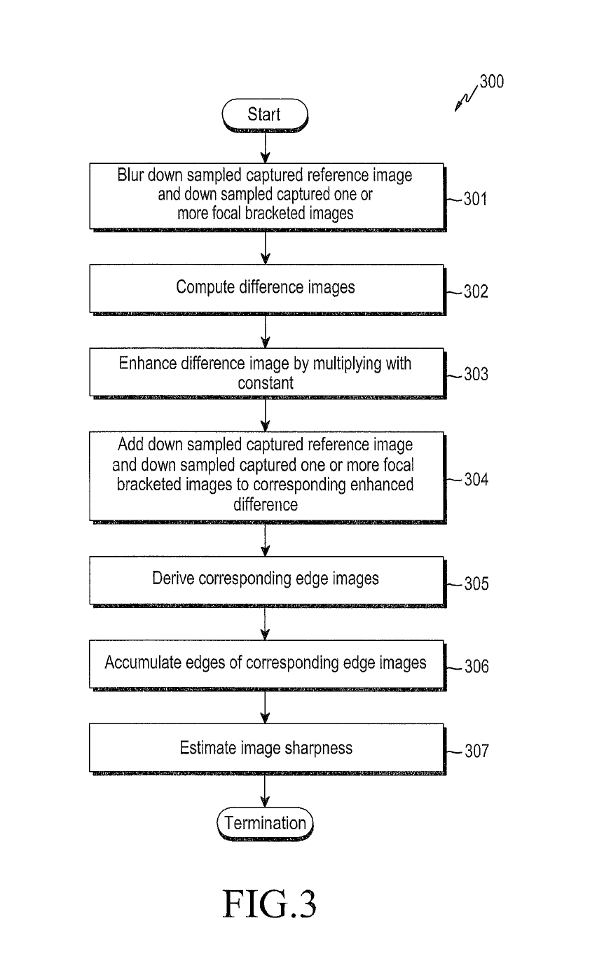

FIG. 3 illustrates an example flow diagram of sharpness estimation of the down sampled captured reference image (also referred to as a down sampled reference image) and the down sampled one or more captured focal bracketed images (also referred to as a down sampled one or more focal bracketed images) according to an embodiment of the present disclosure. As depicted in FIG. 3 300, in step 301, the down sampled reference image and the down sampled one or more focal bracketed images can be blurred to generate a corresponding blurred image of the down sampled reference image and corresponding blurred image of the down sampled aligned one or more focal bracketed images. The blurring can provide smoothening effect on the images and can be performed using filters such as a Gaussian filter or any other smoothening filters. The size of a filter for the blurring, such as the blur filter is m×m, where m is greater than 1.

Further, in step 302, a difference image for the down sampled reference image and the corresponding blurred reference image can be computed. Further, a difference image for the down sampled aligned one or more focal bracketed image and the corresponding blurred image of the aligned captured one or more focal bracketed image can be computed. Then, in step 303, every computed difference image can be enhanced by multiplying with a factor k, where ‘k’ is a positive integer greater than one.

In an embodiment the value of k can be preconfigured in the image capturing.

In an embodiment the value of k can be dynamically selected during processing of the reference image for generating defocused image. For example, the value of k can be derived from Equation 1 provided below:

$$k = \frac{maximum intensity value}{maximum value in difference image} \qquad 〈 Equation 1 〉$$

Where, k value can be decided dynamically based on the maximum value in the difference image.

Further, at step 304 the down sampled reference image and one or more focal bracketed images can be added to their corresponding enhanced difference to get a non-linear edge enhancement image. The non-linear edge enhancement can avoid foreground sharp boundary regions such as human hair, bushes or the like being misclassified as background.

Thereafter, in step 305, corresponding edge images of the enhanced difference images can be derived. The edge image can be derived by applying image sharpness operators such as Prewitt, Sober, Canny or the like to each non-linear edge enhancement edge image. Further, in step 306, filtering on a corresponding edge image of the down sampled reference image and the corresponding edge image of the down sampled can align one or more focal bracketed image using an average filter to accumulate edges of the corresponding edge images. The edge accumulation can provide each pixel value with the average of the pixel and its neighboring pixels defined over a block of the average filter used. The edge accumulation can spread edges in an image.

In step 307, after estimating sharpness of entire set of edge images by accumulating edges, the sharpness estimation process can be terminated. The various operations (steps) in FIG. 3 300 can be performed in the order presented, in a different order or simultaneously. Further, in some embodiments, some operations listed in FIG. 3 can be omitted.

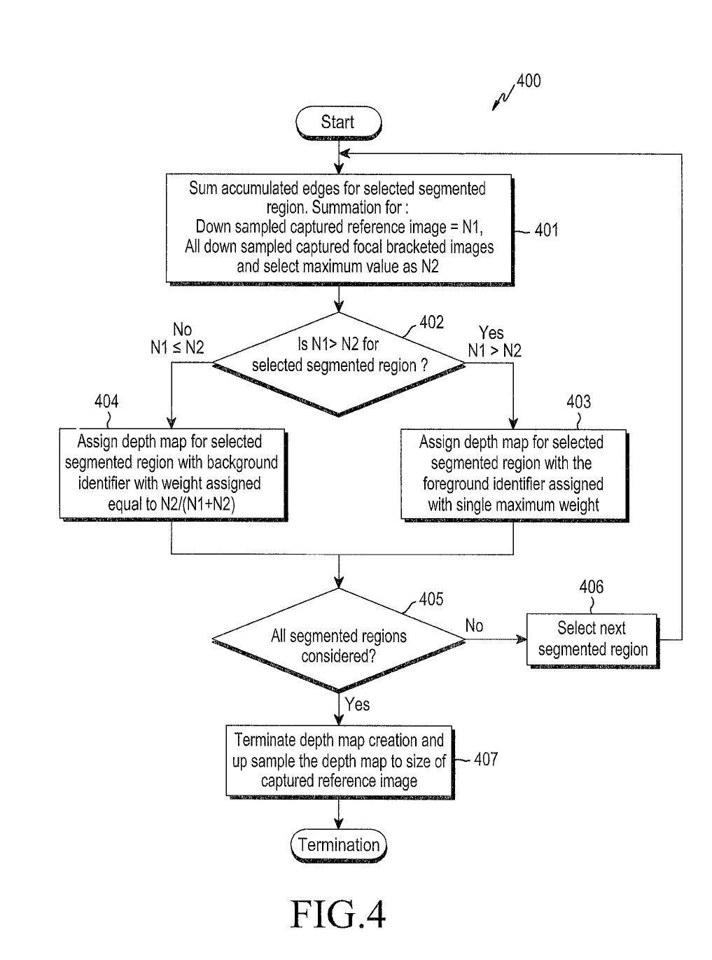

FIG. 4 illustrates an example flow diagram of the creation of a depth map by assigning the foreground identifier and the weighted background identifier to the pixels of the captured reference image according to an embodiment of the present disclosure. As depicted in FIG. 4 400, in step 401, accumulated edges over the selected segmented region in the edge image corresponding to down sampled reference image can be summed up to value N1. Also, the accumulated edges over the selected segmented region in all the edge images corresponding to down sampled one or more focal bracketed images can be summed up individually and the maximum value out of these values is selected as N2. Further, in step 402, the summed accumulated edges N1 and N2 over the selected segmented region can be compared. If N1>N2 the pixels within the selected segmented region are identified as pixels of the foreground of the reference image and in step 403, the depth map (values) for the pixels can be assigned the foreground identifier.

The foreground identifier can be a single maximum weight assigned to all identified foreground pixels. If N1 is less than or equal to N2 (N1<=N2) the pixels within the selected segmented region can be identified as pixels of the background of the reference image and can be assigned the background identifier in the depth map. Further, in step 404, the depth map for pixels of selected segmented region can be assigned the weighted background identifier with weight derived from equation N2/(N1+N2). The N1 and N2 values can be computed from the summed accumulated edges which are further based on estimated sharpness as described in FIG. 3. Thus the weight or value of background identifier assigned can be based on the estimated sharpness level of the selected segmented region.

Thereafter, in step 405, a check can be performed to confirm whether entire segmented regions are considered for depth map creation. If any segmented regions are left to be considered, then in step 406, the next segmented region can be selected for depth map creation and steps 401 to 405 can be repeated. If all segmented regions are considered, then in step 407, the depth map creation process can be terminated and the depth map can be up sampled to the size of the reference image. The various operations (steps) in FIG. 4 400 can be performed in the order presented, in a different order or simultaneously. Further, in some embodiments, some operations listed in FIG. 4 can be omitted.

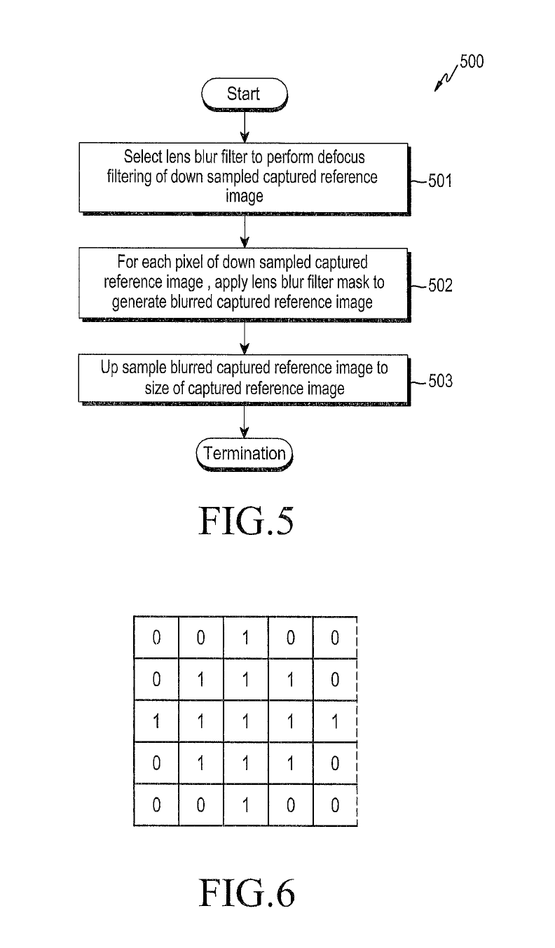

FIG. 5 illustrates an example flow diagram for defocus filtering of the down sampled captured reference image according to an embodiment of the present disclosure. As depicted in FIG. 5 500, in step 501 the lens blur filter can be selected to perform defocus filtering of down sampled reference image. Further, in step 502, the selected lens blur filter can be applied to every pixel of the down sampled reference image to generate the blurred reference image. Thereafter, at step 503, the blurred reference image can be up sampled, to the size of the reference image. The various operations (steps) in FIG. 5 500 can be performed in the order presented, in a different order or simultaneously. Further, in some embodiments, some operations listed in FIG. 5 can be omitted.

FIG. 6 illustrates an example lens blur filter mask for defocus filtering of the down sampled captured reference image according to an embodiment of the present disclosure. Referring to FIG. 6, the figure depicts a 5×5 lens blur filter mask with values of 0 and 1 specified at pre-determined locations of columns and row locations of the mask to provide the blurring effect on every pixel of the down sampled reference image to generate the blurred reference image.

In an embodiment, variable size mask (rows×columns) can be used based on the desired quality and/or desired visual effect of fusion image to be composed.

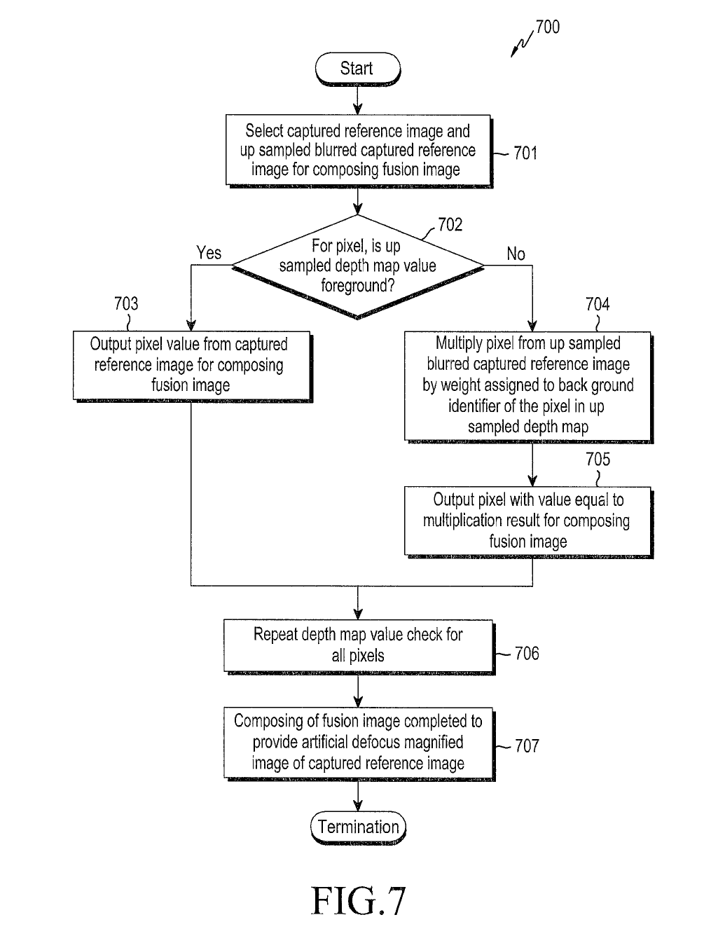

FIG. 7 illustrates an example flow diagram for composing the fusion image from the captured reference image and the up sampled blurred reference image according to an embodiment of the present disclosure. As depicted in FIG. 7 700, in step 701, the reference image and the up sampled blurred reference image can be selected for composing fusion image to generate natural defocused image. Depth map diffusion can be performed on the images using image processing techniques such as a Gaussian pyramid or the like, to smoothly blend the blurred and original reference images. The depth map can consist of batches of foreground and background. If the depth map can be used directly, the output defocus image may not provide smooth boundary transition between foreground and background as changes in the weight map are abrupt between foreground and background. According to an embodiment of the present disclosure, smoothening of the abrupt can change by diffusion of depth map using a Gaussian pyramid method or the like is provided. The fusion image can provide artificial defocus blurring of the reference image. In step 702, a check can be performed on the up sampled depth map value of each pixel. If the corresponding depth map for the pixel under consideration can be associated with the foreground identifier, then in step 703, the corresponding pixel value from captured reference image can be considered for composing fusion image. If the corresponding depth map for the pixel under consideration can be associated with the background identifier, then in step 704, the corresponding pixel value from blurred reference image can be multiplied by weight assigned to the background identifier in the corresponding up sampled depth map value of the pixel. Thereafter, in step 705, pixel with value equal to the multiplication result can be considered for composing fusion image. Then, in step 706, the depth map value check procedure can be repeated for all pixels. Thereafter, in step 707, after entire pixels are checked, composing of fusion image can be completed to generate a defocused image of captured reference image. The fusion image provides a visual effect to the reference image with clear foreground and with gradual blurred background. The various operations (steps) in FIG. 7 700 can be performed in the order presented, in a different order or simultaneously. Further, in some embodiments, some operations listed in FIG. 7 can be omitted.

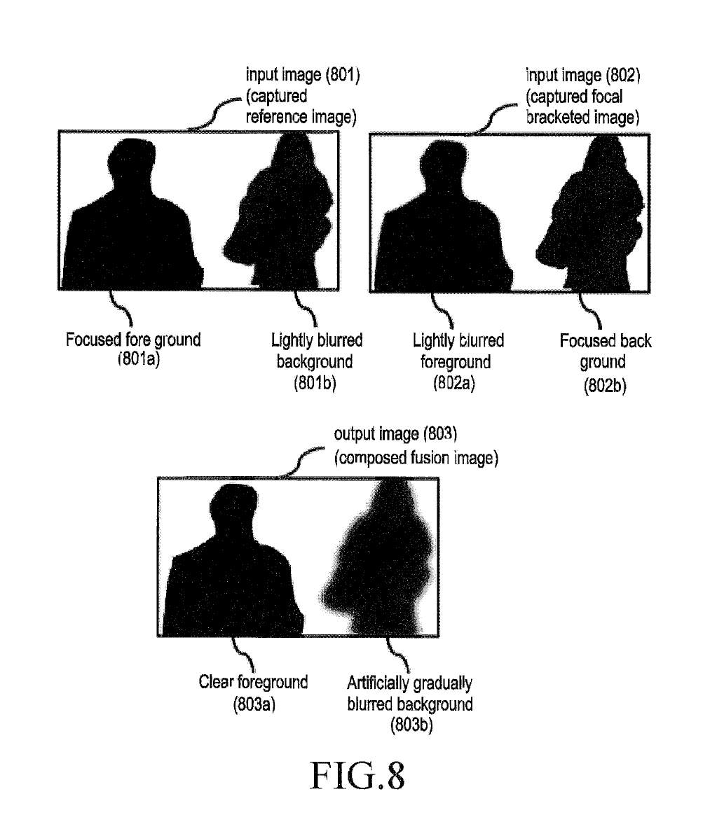

FIG. 8 illustrates an example of a captured reference image, focal bracketed image and composed fusion image according to an embodiment of the present disclosure. FIG. 8 depicts an input image 801 (captured reference image) with a focused foreground 801a and a lightly blurred background 801b. FIG. 8 also depicts an input image 802 (captured focal bracketed image) with a lightly blurred foreground 802a and a focused background 802b. FIG. 8 further depicts an output image 803 (composed fusion image) having clear foreground 803a with artificially gradually blurred background 803b. The captured reference input image 801 can provide the focused foreground 801a where the camera focus is on prime subject of a captured scene. The input image 801a can provide the lightly blurred background 801b. The background can include all objects in the scene other than the prime subject. The input image 802 which is the captured focal bracketed image can provide the lightly blurred foreground 802a, where camera focus is shifted from the prime object of the scene to the background objects of the scene. The input focused image 802 can capture the scene with the focused background 802b. The output image 803 can be the composed fusion image generated by processing the input image 801 and input image 802 depending on operations according to the embodiments of the present disclosure. The output image 803 can provide the clear foreground 803a with prime subject of the scene in focus. The output image 803b can be the artificially defocused blurred image that can provide the artificially gradually blurred background 803b where the background objects of the scene provide artificial gradual blurring to provide an effect similar to the image captured by the camera having a larger lens aperture.

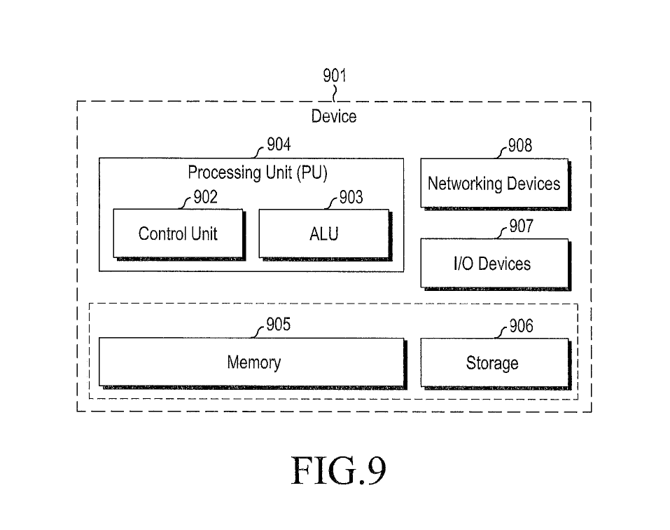

FIG. 9 illustrates an example block diagram for a construction of a device (also referred to as image capturing device) implementing the artificial defocus blurring of the captured reference image according to an embodiment of the present disclosure.

As shown in FIG. 9, a device 901 implementing the artificial defocus blurring of the captured reference image can include at least one processing unit 904 that can be equipped with a control unit 902 and an Arithmetic Logic Unit (ALU) 903, a memory 905, a storage unit 906, a plurality of networking devices 908 and a plurality Input output (I/O) devices 907. The processing unit 904 can be responsible for processing the instructions of the algorithm. The processing unit 904 can receive commands from the control unit in order to perform its processing. Further, any logical and arithmetic operations involved in the execution of the instructions can be computed with the help of the ALU 903.

The overall device 901 can be composed of multiple homogeneous and/or heterogeneous cores, multiple CPUs of different kinds, special media and other accelerators. The processing unit 904 can be responsible for processing the instructions of the algorithm. Further, the plurality of processing units 904 can be located on a single chip or over multiple chips.

The algorithm comprising of instructions and codes required for the implementation can be stored in either the memory unit 905 or the storage 906 or both. At the time of execution, the instructions can be fetched from the corresponding memory 905 and/or storage 906, and executed by the processing unit 904.

In case of any hardware implementations various networking devices 908 or external I/O devices 907 can be connected to the device 901 to support the implementation through the networking unit and the I/O device unit.

The embodiments disclosed herein can be implemented through at least one software program running on at least one hardware device and performing network management functions to control the elements. The elements shown in FIG. 9 can include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein. Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of generating an artificially defocused blurred image, the method comprising:
compensating for zoom of a focal bracketed image based on at least one zoom compensation parameter for aligning at least one captured focal bracketed image with a captured reference image;
creating a depth map for at least one pixel in at least one segmented region by down sampling the reference image;
generating a blurred reference image by performing defocused filtering on the down sampled reference image using a lens blur filter; and
composing a fusion image using at least one image between the captured reference image and an up sampled blurred reference image based on an up sampled depth map for generating the artificially defocused blurred image.

2. The method as in claim 1, wherein the at least one zoom compensation parameter is calibrated using at least one parameter related to an image capturing device and the captured reference image and the focal bracketed image are captured by the image capturing device.

3. The method as in claim 1, wherein the creating of the depth map is based on at least one of an estimated sharpness of the down sampled reference image or an estimated sharpness of the down sampled aligned focal bracketed image.

4. The method as in claim 3, wherein the deriving of the estimated sharpness of the down sampled reference image further comprises:
blurring the down sampled reference image and generating a first blurred image corresponding to the down sampled reference image;
computing a first difference image which comprises a difference between the down sampled reference image and the first blurred image;
enhancing the first difference image;
adding the down sampled reference image to the enhanced first difference image and deriving a first edge image; and
performing filtering on the first edge image using an average filter and accumulating edges of the first edge image.

5. The method as in claim 4, wherein the deriving of the estimated sharpness of the down sampled aligned focal bracketed image further comprises:
blurring the down sampled aligned focal bracketed image and generating a second blurred image corresponding to the down sampled aligned focal bracketed image;
computing a second difference image which comprises a difference between the down sampled aligned focal bracketed image and the second blurred image;
enhancing the second difference image;
adding the down sampled aligned focal bracketed image to the enhanced second difference image and deriving a second edge image; and
performing filtering on the second edge image using an average filter and accumulating edges of the second edge image.

6. The method as in claim 1, wherein the at least one segmented region is obtained by segmenting the down sampled reference image using region based segmentation.

7. The method as in claim 1, wherein the aligning of the focal bracketed image with the captured reference image further comprises performing at least one of a translation compensation or a rotation compensation on the focal bracketed image.

8. The method as in claim 5, wherein the creating of the depth map further comprises summing the accumulated edges of the first edge image and the accumulated edges of the second edge image,
wherein the summing of the accumulated edges is performed over the at least one segmented region of the down sampled reference image, and comprises:
comparing the accumulated edges of the first edge image and the accumulated edges of the second edge image; and
assigning one identifier to at least one of a background identifier or a foreground identifier to the at least one pixel of the at least one segmented region of the down sampled reference image.

9. The method as in claim 8, wherein the foreground identifier identifying a foreground of the down sampled reference image is assigned with a maximum weight and the background identifier identifying a background of the down sampled reference image is assigned with a background weight among one or more background weights based on the estimated sharpness of the at least one segmented region of the down sampled reference image.

10. The method as in claim 1, wherein generating an artificially defocused blurred image is performed in one of a mobile phone, a tablet Personal Computer (PC), a Personal Digital Assistant (PDA), a webcam, or a compact digital camera.

11. An image capturing device configured to generate an artificially defocused blurred image, wherein the image capturing device comprising:
an integrated circuit which further comprises at least one processor; and
at least one memory which has a computer program code within the integrated circuit,
wherein the at least one memory and the computer program code with the at least one processor is configured to cause the image capturing device to:
compensate for zoom of a focal bracketed image based on at least one zoom compensation parameter for aligning at least one captured focal bracketed image with a captured reference image;
create a depth map for at least one pixel in at least one segmented region by down sampling the reference image;
generate a blurred reference image by performing defocus filtering on the down sampled reference image using a lens blur filter; and
compose a fusion image using at least one image between the captured reference image and an up sampled blurred reference image based on an up sampled depth map for generating the artificially defocused blurred image.

12. The image capturing device as in claim 11, wherein the image capturing device is configured to calibrate the at least one zoom compensation parameter using at least one parameter related to the image capturing device.

13. The image capturing device as in claim 11, wherein the image capturing device is configured to create the depth map based on at least one of an estimated sharpness of the down sampled reference image or an estimated sharpness of a down sampled aligned focal bracketed image.

14. The image capturing device as in claim 13, wherein the image capturing device is further configured to derive the estimated sharpness by:
blurring the down sampled reference image and generating a first blurred image corresponding to the down sampled reference image;
computing a first difference image which comprises a difference between the down sampled reference image and the first blurred image;
enhancing the first difference image;
adding the down sampled reference image to the enhanced first difference image and deriving a first edge image; and
performing filtering on the first edge image using an average filter and accumulating edges of the first edge image.

15. The image capturing device as in claim 13, wherein the image capturing device is further configured to derive the estimated sharpness of the down sampled aligned focal bracketed image by:
blurring the down sampled aligned focal bracketed image and generating a second blurred image corresponding to the down sampled aligned focal bracketed image;
computing a second difference image which comprise a difference between the down sampled aligned focal bracketed image and the second blurred image;
enhancing the second difference image;
adding the down sampled aligned focal bracketed image to the enhanced second difference image and deriving a second edge image; and
performing filtering on the second edge image using an average filter and accumulating edges of the second edge image.

16. The image capturing device as in claim 11, wherein the image capturing device is further configured to segment the down sampled reference image to obtain the at least one segmented region using region based segmentation.

17. The image capturing device as in claim 15, wherein the image capturing device is further configured to align the focal bracketed image with the captured reference image by performing at least one compensation between a translation compensation and a rotation compensation on the focal bracketed image.

18. The image capturing device as in claim 15, wherein the image capturing device is further configured to create the depth map by summing of the accumulated edges of the first edge image and the accumulated edges of the second edge image,
wherein the summing of the accumulated edges is performed over the at least one segmented region of the down sampled reference image, and comprises:
comparing the accumulated edges of the first edge image and the accumulated edges of the second edge image; and
assigning one identifier between a background identifier and a foreground identifier to the at least one pixel of the at least one segmented region of the down sampled reference image.

19. The image capturing device as in claim 18, wherein the image capturing device is configured to assign a maximum weight to the foreground identifier identifying a foreground of the down sampled reference image and assign a background weight among one or more background weights to the background identifier identifying a background of the down sampled reference image based on the estimated sharpness of the at least one segmented region of the down sampled reference image.

20. The image capturing device as in claim 11, wherein the image capturing device is a component of one of a mobile phone, a tablet Personal Computer (PC), a Personal Digital Assistant (PDA), a webcam, or a compact digital camera.
